(19) United States
(12) Patent Application Publication
(10) Pub. No.: US 2010/0329185 A1
(43) Pub. Date: Dec. 30, 2010

(54) SUBSCRIBER STATION, BASE STATION, AND SERVICE FLOW ESTABLISHING METHOD

(75) Inventor: LI-JEN HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/730,247

(22) Filed: Mar. 24, 2010

(30) Foreign Application Priority Data
Jun. 26, 2009 (CN) 200910303719.1

(51) Int. Cl. H04W 40/00

(52) U.S. Cl. 370/328

(57) ABSTRACT

A subscriber station in communication with a base station transmits a request (REQ) packet to the base station to request an establishment of service flow between the subscriber station and the base station, starts a first timer to time a preset period determined according to the REQ packet, receive a response (RSP) packet from the base station to determine if the base station currently permits the establishment of service flow with the subscriber station. The subscriber station further receives a RSP-DELAY packet from the base station before the first timer times out if the base station does not currently permit the establishment of service flow with the subscriber station, and establishes the service flow with the base station according to the RSP-DELAY packet.

### BACKGROUND

1. Technical Field

Embodiments of the present disclosure relate to wireless communication, and more particularly to a subscriber station, a base station, and a service flow establishing method therebetween.

2. Description of Related Art

In the IEEE 802.16 standard, a subscriber station (SS) is required to request a service flow establishment with a base station (BS). The service flow is dynamically added for transmitting and receiving user data between the SS and the BS. The BS may refuse the request if the BS is overloaded, which is defined to mean that the BS is running out of bandwidth resources. An overloaded BS cannot provide other service flows with the SS anymore.

The SS is required to end the request or establish a lower level service flow if the BS refuses the request. After the refusal, the BS will not communicate with the SS anymore. Therefore, even when the system load of the BS has decreased, the SS is required to employ the lower level service flow or periodically request the BS, which exhausts both the BS and the SS.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a subscriber station and a base station of the present disclosure;

FIG. 2 is a schematic diagram of a handshake to establish a service flow between the subscriber station and the base station in FIG. 1;

FIG. 3 is a flowchart of one embodiment of a service flow establishing method of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

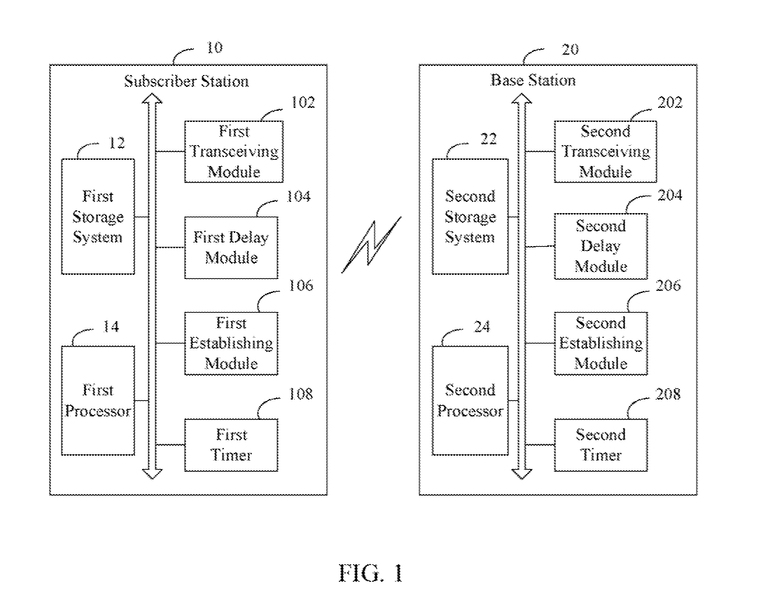

FIG. 1 is a schematic diagram of functional modules of one embodiment of a subscriber station (SS) 10 and a base station (BS) 20 of the present disclosure. The SS 10 requires establishing a service flow with the BS 20.

In one embodiment, the SS 10 includes a first storage system 12, a first processor 14, a first transceiving module 102, a first delay module 104, a first establishing module 106, and a first timer 108. The modules 102-108 may include one or more computerized instructions stored in the storage system 12 and executed by the first processor 14.

In one embodiment, the BS 20 includes a second storage system 22, a second processor 24, a second transceiving module 202, a second delay module 204, a second establishing module 206, and a second timer 208. The modules 202-208 may include one or more computerized instructions stored in the storage system 22 and executed by the second processor 24.

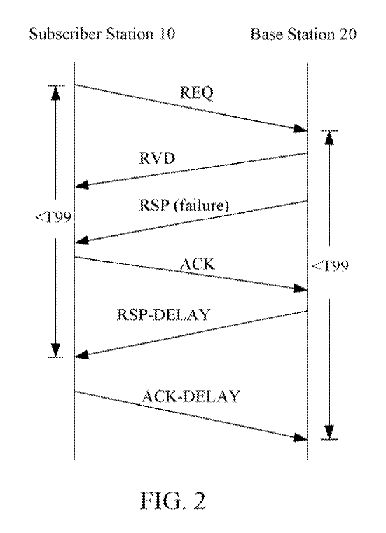

FIG. 2 is a schematic diagram of handshake to establish a service flow between the SS 10 and the BS 20 in FIG. 1.

In FIG. 2, the first transceiving module 102 transmits a request (REQ) packet to the second transceiving module 202 to establish the service flow between the SS 10 and the BS 20. The first transceiving module 102 starts the first timer 108 to time a preset period T99 determined according to the REQ packet.

The second transceiving module 202 receives the REQ packet from the first transceiving module 102 and then replies with a Received (RVD) packet to the first transceiving module 102 to acknowledge the REQ packet. The second transceiving module 202 starts the second timer 208 to time the preset period T99 determined according to the REQ packet.

If the BS 20 is overloaded when the second transceiving module 202 receives the REQ packet, the BS 20 refuses the request from the SS 10 and does not permit establishment of the service flow with the SS 10, that is, the service flow request from the SS 10 fails. If the BS 20 is overloaded, the BS 20 currently permits establishment of the service flow with the SS 10. The second transceiving module 202 transmits a response (RSP) packet to the first transceiving module 102 to notify the SS 10 whether the BS 20 permits the service flow establishment with the SS 10 currently or not.

The first transceiving module 102 determines if the BS 20 currently permits the service flow establishment with the SS 10 according to the RSP packet. If the BS 20 does not currently permit the service flow establishment with the SS 10, the first transceiving module 102 transmits an acknowledgement (ACK) packet to the second transceiving module 202 to acknowledge the RSP packet.

The second delay module 204 determines if the BS 20 permits the service flow establishment with the SS 10 during the preset period T99. When the BS 20 can establish the service flow with the SS 10, the second delay module 204 transmits a RSP-DELAY packet to the first delay module 104 before the second timer 208 times out to notify the SS 10 that the BS 20 can establish the service flow with the SS 10.

The first delay module 104 determines if the RSP-DELAY packet is received before the first timer times out. If the first delay module 104 receives the RSP-DELAY packet before the first timer times out, the first delay module 104 transmits an ACK-DEALY packet to the second delay module 204 to notify the BS 20 to establish the service flow. After the second delay module 204 receives the ACK-DEALY packet, the first establishing module 206 and the second establishing module 208 establishes the service flow between the SS 10 and the BS 20.

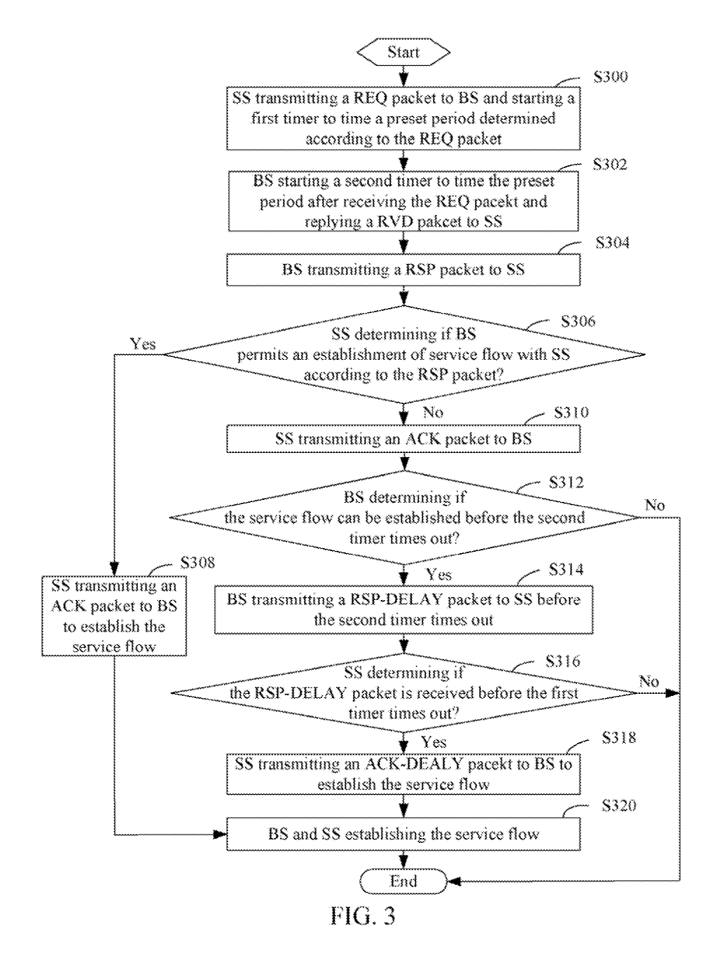

FIG. 3 is a flowchart of one embodiment of the service flow establishing method of the present disclosure. The method may be embodied in the SS 10 and the BS 20, and is executed by the functional modules such as those of FIG. 1. Depending on the embodiment, additional blocks may be added, others deleted, and the ordering of the blocks may be changed while remaining well within the scope of the disclosure.

In block S300, the first transceiving module 102 transmits a REQ packet to the second transceiving module 202 to request the establishment of the service flow between the SS 10 and the BS 20. In block S301, the first transceiving module 102 starts the first timer 108 to time a preset period T99 determined according to the REQ packet.

In block S302, the second transceiving module 202 receives the REQ packet from the first transceiving module 102 and then replies a RVD packet to the first transceiving module 102 to acknowledge the REQ packet. In block S303, the second transceiving module 202 starts the second timer 208 to time the preset period T99.

In block S304, the second transceiving module 202 transmits a RSP packet to the first transceiving module 102 to notify the SS 10 whether the BS 20 currently permits the service flow establishment with the SS 10 or not. For example, if the total bandwidth of the BS 20 is 100 MHz and 90 MHz is already employed, the available bandwidth of the BS 20 is 10 MHz. If the service flow from the SS 10 requires 20 MHz, then the BS 20 does not currently permit the service flow establishment with the SS 10. In comparison, if the service flow from the SS 10 requires 5 MHz, then the BS 20 currently permits the service flow establishment with the SS 10.

In block S306, the first transceiving module 102 determines if the BS 20 currently permits the service flow establishment with the SS 10 according to the RSP packet. If the BS 20 currently permits the service flow establishment with the SS 10, in block S308, the first transceiving module 102 transmits an ACK packet to the second transceiving module 202 to establish the service flow. In block S320, the first establishing module 206 and the second establishing module 208 establishes the service flow between the SS 10 and the BS 20.

If the BS 20 does not currently permit the service flow establishment with the SS 10, then in block S310, the first transceiving module 102 transmits an ACK packet to the second transceiving module 202 to acknowledge the RSP packet.

As the employed bandwidth is changeable, the available bandwidth of the BS 20 is changeable. In block S312, the second delay module 204 determines if the BS 20 permits the service flow establishment with the SS 10 during the preset period T99. For example, if the total bandwidth of the BS 20 is 100 MHz and the employed bandwidth changes from 90 MHz to 30 MHz before the second timer 208 times out, the available bandwidth of the BS 20 changes from 10 MHz to 70 MHz. If the service flow from the SS 10 requires 20 MHz, then the BS 20 permits the service flow establishment with the SS 10 after the change of the employed bandwidth.

When the BS 20 can establish the service flow with the SS 10, in block S314, the second delay module 204 transmits a RSP-DELAY packet to the first delay module 104 before the second timer 208 times out to notify the SS 10 that the BS 20 can establish the service flow with the SS 10.

In block S316, the first delay module 104 determines if the RSP-DELAY packet is received before the first timer times out. If the first delay module 104 receives the RSP-DELAY packet before the first timer times out, then in block S318, the first delay module 104 transmits an ACK-DEALY packet to the second delay module 204 to notify the BS 20 to establish the service flow. After the second delay module 204 receives the ACK-DEALY packet, in block S320, the first establishing module 206 and the second establishing module 208 establishes the service flow between the SS 10 and the BS 20.

In one embodiment, those packets may be dynamic service addition (DSA) packets. In other embodiments, those packets may be dynamic service change (DSC) packets or dynamic service deletion (DSD) packets.

The BS 20 of the present disclosure first refuses to establish a service flow with the SS 10 if the BS 20 is overloaded and secondary notifies the SS 10 during the preset period T99 when the system load of the BS 20 decreases. Therefore, when the system load of the BS 20 is decreased, the SS 10 can establish the service flow with the BS 20, which improves the efficiency of the SS 10 and the BS 20.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A subscriber station in communication with a base station, the subscriber station comprising a processor, a storage system, and one or more programs, wherein the one or more programs are stored in the storage system and operable to be executed by the processor, and comprise:
a first transceiving module operable to transmit a request (REQ) packet to the base station to request an establishment of service flow between the subscriber station and the base station, to start a first timer to time a preset period determined according to the REQ packet, and to receive a response (RSP) packet from the base station and determine if the base station currently permits the establishment of service flow with the subscriber station according to the RSP packet;
a first delay module operable to receive a RSP-DELAY packet from the base station before the first timer times out if the base station does not currently permit the establishment of service flow with the subscriber station, and to transmit an acknowledgement-delay (ACK-DEALY) packet to the base station to notify the base station to establish the service flow if the RSP-DELAY packet has been received before the first timer times out; and
a first establishing module operable to establish the service flow with the base station according to the RSP-DELAY packet.

2. The subscriber station as claimed in claim 1, wherein the first transceiving module is further operable to transmit an ACK packet to the base station to acknowledge the RSP packet if the base station does not currently permit the establishment of service flow with the subscriber station.

3. The subscriber station as claimed in claim 1, wherein the first establishing module is operable to establish the service flow with the base station if the base station currently permits the establishment of service flow with the subscriber station according to the RSP packet.

4. The subscriber station as claimed in claim 1, wherein the first delay module stops to receive the RSP-DELAY packet from the base station if the first timer times out.

5. A base station in communication with a subscriber station, the base station comprising a processor, a storage system, and one or more programs, wherein the one or more programs are stored in the storage system and operable to be executed by the processor, the base station comprising:
a second transceiving module operable to receive a request (REQ) packet to request establishment of service flow between the subscriber station and the base station from the subscriber station, to reply a received (RVD) packet to the subscriber station to acknowledge the REQ packet, to start the second timer to time a preset period determined according to the REQ packet, and to transmit a response (RSP) packet to the subscriber station to notify the subscriber station whether the base station currently permits the establishment of service flow with the subscriber station or not;
a second delay module operable to determine if the base station permits the establishment of service flow with the subscriber station before the second timer times out, to transmit a RSP-DELAY packet to the first delay module to notify the subscriber station that the base station can establish the service flow with the subscriber station before the second timer times out, and to receive an ACK-DEALY packet from the subscriber station; and
a second establishing module operable to establish the service flow with the subscriber station after the ACK-DEALY packet is received.

6. A service flow establishing method between a subscriber station and a base station, comprising:
the subscriber station transmitting a REQ packet to the base station to request an establishment of service flow with the base station and starting a first timer to time a preset period determined according to the REQ packet;
the base station replying a RVD packet to the subscriber station after receiving the REQ packet to acknowledge the REQ packet and starting a second timer to time the preset period;
the base station transmitting a RSP packet to the subscriber station to notify whether the base station currently permits the establishment of service flow with the subscriber station or not;
the subscriber station determining if the base station currently permits the establishment of service flow with the subscriber station according to the RSP packet;
the subscriber station transmitting an ACK packet to the base station to acknowledge the RSP packet if the base station does not permit the establishment of service flow with the subscriber station;
the base station determining if the service flow can be established before the second timer times out;
the base station transmitting a RSP-DELAY packet to the subscriber station before the second timer times out when the service flow can be established before the second timer times out;
the subscriber station determining if the RSP-DELAY packet is received before the first timer times out;
the subscriber station transmitting an ACK-DEALY packet to the base station; and
the subscriber station establishing the service flow with the base station if the RSP-DELAY packet is received before the first timer times out.

7. The method as claimed in claim 6, further comprising the subscriber station transmitting an ACK packet to the base station and establishing the service flow with the base station if the base station permits the establishment of service flow with the subscriber station.

8. The method as claimed in claim 6, further comprising the subscriber station ending the service flow request to the base station if the service flow cannot be established before the second timer times out.

9. The method as claimed in claim 6, further comprising the subscriber station ending the service flow request if the RSP-DELAY packet is not received before the first timer times out.
